(19) United States
(12) Patent Application Publication
(10) Pub. No.: US 2026/0184547 A1
(43) Pub. Date: Jul. 2, 2026

(54) ATTACHMENT MEANS FOR LIFTING AND TRANSPORATION DEVICE

(71) Applicant: RIHA Industries Pty Ltd, Edinburgh North (AU)

(72) Inventor: Nicolas Ritter, Edinburgh North (AU)

(73) Assignee: RIHA Industries Pty Ltd, Edinburgh North (AU)

(21) Appl. No.: 19/422,250

(22) Filed: Dec. 16, 2025

(30) Foreign Application Priority Data
Dec. 27, 2024 (AU) 2024904328

(51) Int. Cl. B66F 9/18; A61G 7/08; A61G 12/00

(52) U.S. Cl. CPC B66F 9/18; A61G 7/08; A61G 12/001

(57) ABSTRACT

Disclosed herein are improved attachment means for lifting and transportation devices, particularly for lifting and transporting wheeled objects such as hospital beds. The attachment means include a pair of laterally adjustable spaced apart jaw members, comprising a wheel-receiving portion adapted to receive wheels of the wheeled object. Each jaw member is provided with adjustable assemblies in the form of a hinged block and a slidable plate, enabling the wheel-receiving portion to be adjusted to receive wheels of different diameters.

### TECHNICAL FIELD

The present invention relates to an improved attachment means for a lifting and transportation device. The lifting and transportation device being suitable for lifting and moving objects having spaced apart wheels such as hospital beds and hospital laundry trolleys; the improved attachment means adapted for engaging the wheeled object via its wheels for subsequent lifting and transportation.

### BACKGROUND TO THE INVENTION

A variety of lifting and transportation devices for wheeled objects within hospitals, such as hospital beds and hospital laundry trolleys, are known in the art. It is to be understood that transportation also encompasses moving objects.

The inventor has developed such prior art transportation devices, alternatively referred to as hospital bed movers or bed movers, such as those disclosed in International Patent Publication WO 2012/171079 A1, the entire contents of which is herein incorporated by reference. These bed movers function by engaging the wheels of wheeled objects, rather than its frame, enabling it to attach to objects with differing frame shapes and sizes.

However, known hospital bed movers such as those previously developed by the inventor require difficult user-adjustment of the attachment means, alternatively referred to as its jaw system or jaw mechanism, to accommodate for different wheel sizes. This typically requires the user to adjust the positioning of a spacer block to fit a desired wheel diameter. The adjustment of a spacer block is difficult and leads to operator-caused error in attaching the bed mover to hospital beds.

Furthermore, components in the jaw mechanism of existing hospital beds are prone to ratting when the bed mover is not attached to a wheeled object and being operated, resulting in unwanted noise which may disturb personnel, and particularly patients, in a typically quiet hospital environment.

There is therefore a need to improve upon existing hospital bed mover systems, in particular, its attachment mechanism. It is therefore an object of the present invention to overcome or ameliorate a problem of the prior art or at least provide the public with a useful alternative.

### SUMMARY OF THE INVENTION

According to an aspect of the invention, there is provided an attachment means for a lifting and transportation device suitable for lifting and moving objects with spaced apart wheels, the attachment means comprising:
a pair of laterally adjustable spaced apart jaw members configured to engage wheels of an object;
each jaw member having a plate assembly and a block assembly having a space therebetween configured to receive one of the wheels;
wherein the plate assemblies are slidably adjustable along a length of their respective jaw member; and
wherein each of the plate assembly and the block assembly are adjustable such that the space therebetween can receive wheels of different diameters.

In a preferred embodiment, each of the plate assemblies comprises a surface positioned at an incline, wherein the incline is adapted to accommodate for a curvature of the wheel.

In a preferred embodiment, the plate assembly is slidably adjustable through a linear rail.

In a preferred embodiment, the plate assembly is slidably adjustable between three positions.

In a preferred embodiment, the plate assembly is retained in place using a pin inserted into a slot.

In a preferred embodiment, the block assembly comprises an upper block hingedly affixed to a lower block, such that the block assembly can hingedly adjusted.

In a preferred embodiment, the block assembly can be transitioned between an open and a closed position.

In a preferred embodiment, the block assembly comprises a plurality of magnet sets configured to secure the block assembly in the open or closed position.

In a preferred embodiment, a first and second magnet set of the plurality of magnet sets retain the block assembly in the open position, and wherein the second magnet set and a third magnet set retain the block assembly in the closed position.

In a preferred embodiment, the space between the block assembly and the plate assembly is adjustable between six different positions.

In a preferred embodiment, the jaw members are supported on the ground by castor wheels.

In a further aspect of the invention, there is provided a bed mover comprising the attachment means of any one of the previous claims.

It should be noted that any one of the aspects mentioned above may include any of the features of any of the other aspects mentioned above and may include any of the features of any of the embodiments described below as appropriate.

### BRIEF DESCRIPTION OF THE DRAWINGS

Preferred features, embodiments and variations of the invention may be discerned from the following detailed description which provides sufficient information for those skilled in the art to perform the invention. The detailed description is not to be regarded as limiting the scope of the preceding summary of the invention in any way. The detailed description will make reference to a number of drawings as follows:

FIG. 1 illustrates a perspective view of a hospital bed mover having an attachment means according to a preferred embodiment of the invention;

FIG. 2 illustrates a perspective view of the attachment means of FIG. 1;

FIG. 3 illustrates another perspective view of the attachment means of FIG. 1;

FIG. 4 illustrates a side view of the attachment means of FIG. 1;

FIG. 5 illustrates an exploded view of a plate assembly according to a preferred embodiment of the invention;

FIGS. 6a and 6b illustrates a close-up view of the attachment means of FIG. 1;

FIG. 7 provides an exploded view of a block assembly according to a preferred embodiment of the invention; and

FIGS. 8a and 8b provides a perspective view of the hospital bed mover engaging with, and lifting a hospital bed.

### LIST OF COMPONENTS

The drawings refer to the following reference numerals:

| | | | |
|---|---|---|---|
| 10 | bed mover | 37 | end assembly |
| 12 | drive unit | 46 | outer slider |
| 14 | control unit | 48 | protrusion |
| 16 | handles | 50 | threaded member |
| 18 | control module | 52 | spacer |
| 20 | platform | 54 | aperture |
| 22 | attachment means | 58 | ramp |
| 24 | frame member | 60 | block assembly |
| 26 | jaw member | 62 | upper block |
| 28 | wheel | 64 | lower block |
| 30 | slide member | 66 | axle |
| 32 | guide | 68 | first magnet set |
| 34 | arm member | 70 | second magnet set |
| 36 | guide | 72 | third magnet set |
| 37 | end assembly | 74 | protrusion region |
| 40 | plate assembly | 76 | tapered region |
| 41 | pin element | 80 | hospital bed |
| 42 | plate member | 82 | hospital bed wheel |
| 43 | slot | | |
| 44 | inner slider | | |

### DETAILED DESCRIPTION OF THE INVENTION

The accompanying drawing figures are included to provide further understanding of the present invention and are incorporated in and constitute a part of this specification. The drawings illustrate particular embodiments of the invention and together with the description serve to explain the principles and operation thereof. Other embodiments of the invention and many of the attendant advantages will be readily appreciated as they become better understood with reference to the following detailed description.

It will be appreciated that common and/or well understood elements that may be useful or necessary in a commercially feasible embodiment are not necessarily depicted in order to facilitate a more abstracted view of the embodiments. It will also be understood that certain actions and/or steps in an embodiment of a method may be described or depicted in a particular order of occurrences while those skilled in the art will understand that such specificity with respect to sequence may not actually be required.

The present invention relates to a lifting and transportation device, or hospital bed mover, or bed mover, and, in particular, to an improved attachment means, or jaw mechanism, or jaw system, used to engage the wheels of a wheeled object for lifting and transportation thereof. In particular, the jaw mechanism is adapted to engage and lift the spaced apart wheels of a wheeled object such as a hospital bed, and comprises adjustment means for engaging wheels of different dimensions, orientations, spaced apart distances, and/or wheelbases.

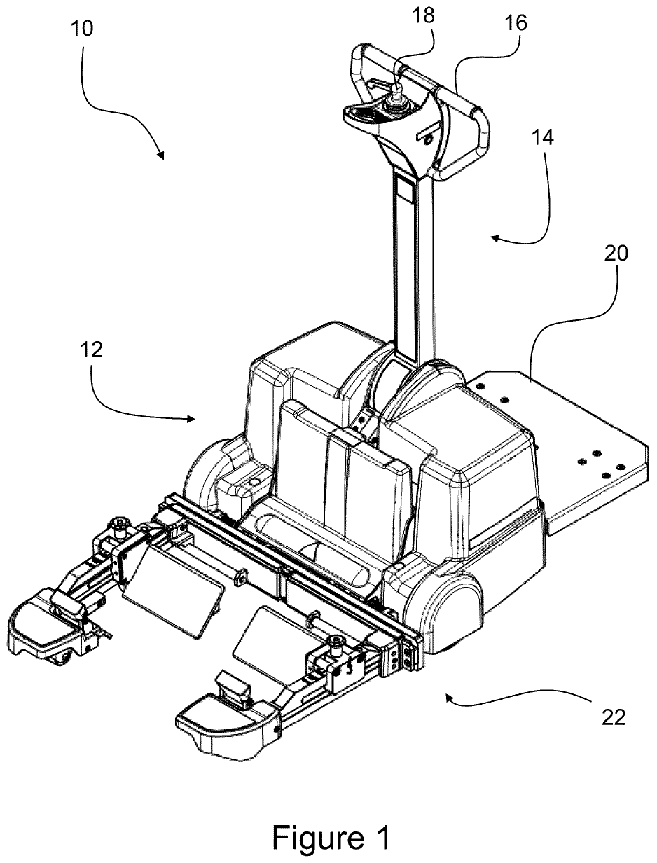

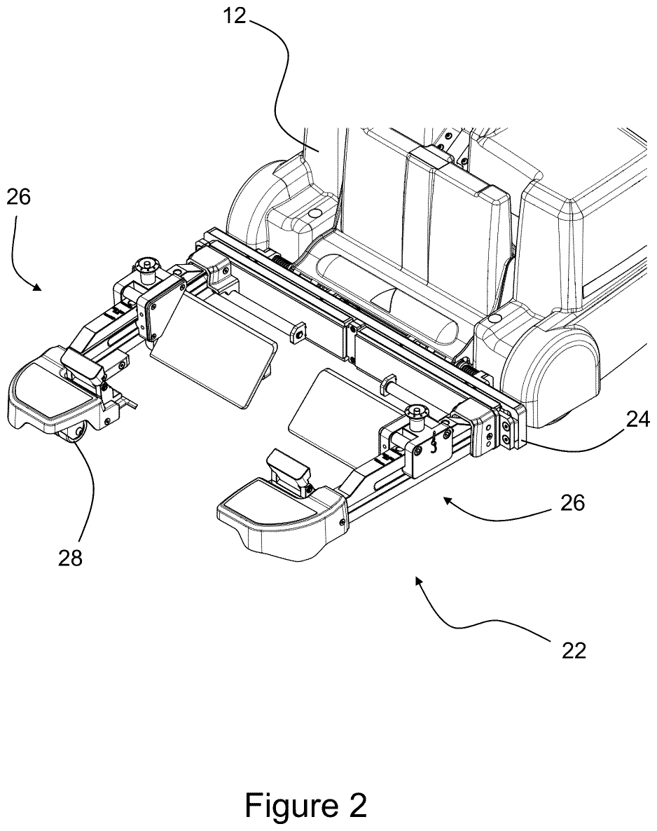

Referring firstly to FIG. 1, there is provided a bed mover 10 according to a preferred embodiment of the invention. The bed mover 10 comprises a drive unit 12 which preferably comprises an internal motor configured to provide movement of the bed mover 10. Attached to the drive unit 12 is a control unit 14 comprising handles 16 and a control module 18 enabling a user to operate and steer the bed mover 10. A platform 20 is provided extending rearwardly from the drive unit 12 that enables a user to stand on the platform 20 while the bed mover 10 is being operated or driven. An attachment means 22 is provided extending proximately from the drive unit 12 that gripping or attachment to the wheels 82 of a hospital bed.

Methods of performing and configurational means of the drive unit 12 and control unit 14 for a hospital bed mover in the art and are disclosed for example in the Applicant's International Patent Publication WO 2012/171079 A1. The basic operation of the attachment means 22 is also known. As such, for the purposes of brevity these components will not be disclosed in detail. Rather, this application will focus on the improved adjustment mechanisms of the attachment means 22 its improvement over the prior art.

Attachment means 22 comprises a frame member 24 affixed to the drive unit 12. A pair of jaw members 26 are affixed to the frame member 24 which are configured to adjustably engage the wheels of a hospital bed. Jaw members 26 are supported on the ground by castor wheels 28, and are capable of lateral adjustment along the frame member 24 to accommodate for, and subsequently engage wheeled objects with varying wheel spacings. This will be made clear from the following description.

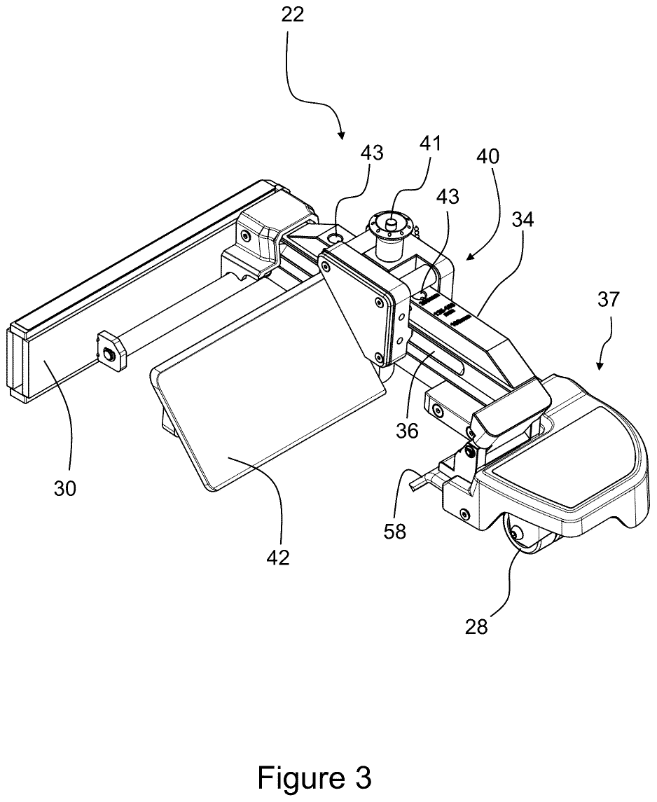

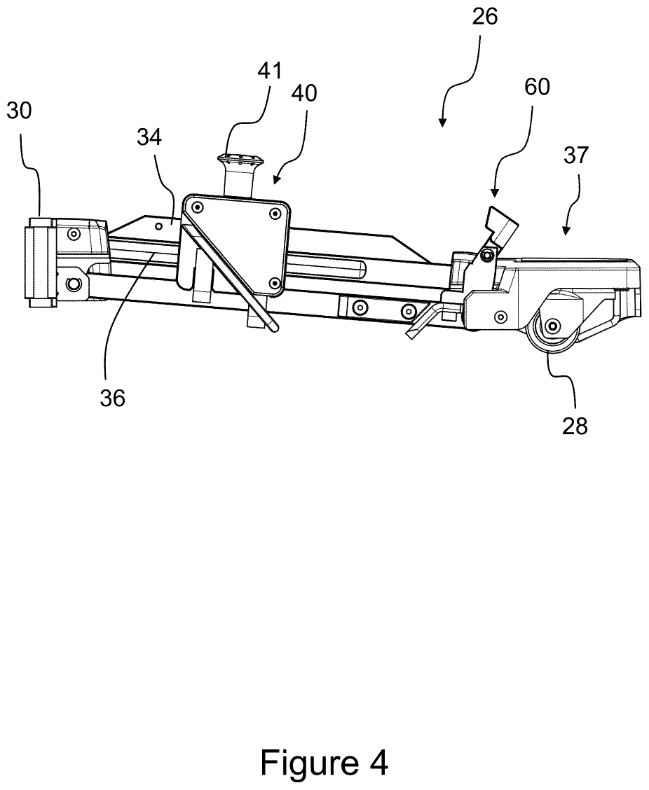

Referring now to FIGS. 3 and 4, there are provided illustrations of a perspective view and top view of a singular jaw member 26. It is to be appreciated that the attachment means 22 comprises symmetrically positioned jaw members 26 with the same, although mirrored, function. Those skilled in the art would be able to ascertain the present invention and the overall attachment means 22 from the following description of singular jaw member 26.

Jaw member 26 comprises a linear rail member 30 having a guide 32 adapted to engage a rail or slide of frame member 24, enabling slidable engagement of jaw member 26 along the frame member 24.

Extending substantially perpendicular from rail member 30 is an arm member 34 terminating having a terminal end with a castor wheel 28 and its associated end assembly 37 which will be described later herein. Arm member 34 is hingedly affixed to slide member 30, which in turn is configured for movement along the vertical axis together with frame member 24 to lifting of, and subsequent transportation of an engaged hospital bed. The hinged attachment of arm 34 to slide member 30 enables lifting of the engaged hospital bed wheels while attachment assembly 22 is simultaneously supported on the ground via castor wheels 28, thereby providing supported movement of the engaged hospital bed.

Arm member 34 comprises a guide portion 36 to which a plate assembly 40 is slidably engaged thereto. Plate assembly 40 may be slidably adjusted to a desired location to accommodate for a required wheel diameter, and subsequently fixed in place via pin element 41 engaging one of the slots 43 located on arm member 34. It is understood a guide 36 is provided on the inside and outside of arm member 34 as illustrated in the Figures.

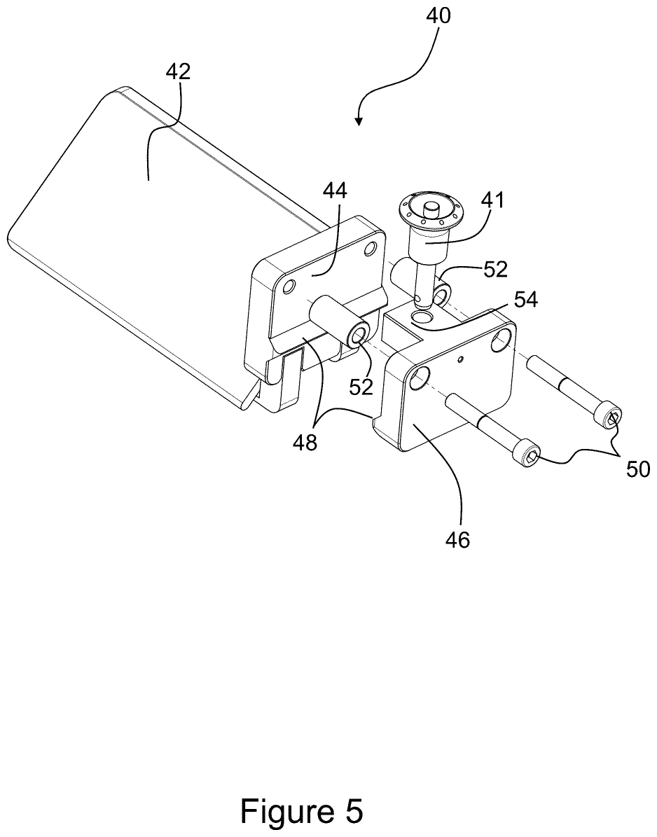

Referring to FIG. 5 there is provided an exploded view of plate assembly 40, comprising a plate member 42 with adjacent inner rail slider 44, outer rail slider 46, and pin element 41. The inner rail slider 44 is attached with the outer rail slider 46 through a plurality of threaded members 50. A spacer 52 is provided in between the sliders 44, 46 to maintain a desired spaced distance. Protrusions 48 are present on the sliders 44, 46 configured to attach to guides 36 (illustrated in FIGS. 3 and 4) which slidably secure the assembly 40 to arm member 34.

The pin element 41 extends through an aperture 54 located on the outer rail slider 46 to engage with one of the slots 43 thereby locking the plate assembly 40 in position. To accommodate for different wheel diameters, and as will be explained further in the description, a user may remove pin 41 from one slot 43, slide the plate assembly to a desired distance from the end assembly 37 so as to accommodate a desired wheel diameter, then reinsert pin 41 through aperture 54 into alternate slot 43.

Plate 42 is a substantially planar surface and is provided at an incline relative to the horizontal. End assembly 37 is provided with a ramp 58 which is symmetrically inclined to plate 42. Ramp 58 and plate 42 are configured so as to receive a wheel in between them, with their inclines adapted to receive and accommodate for the curvature of the wheel for sufficient support during subsequent lifting.

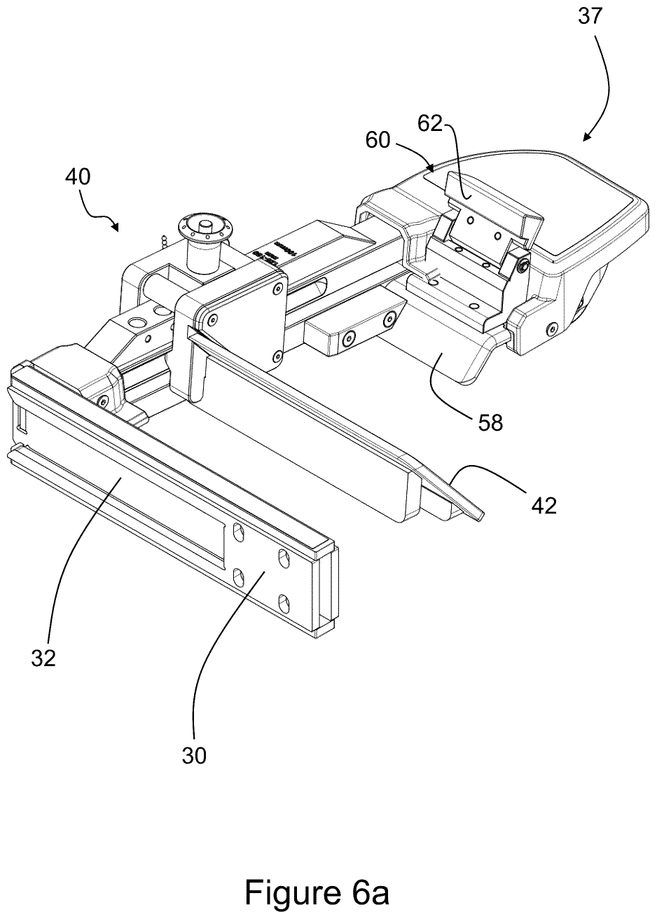

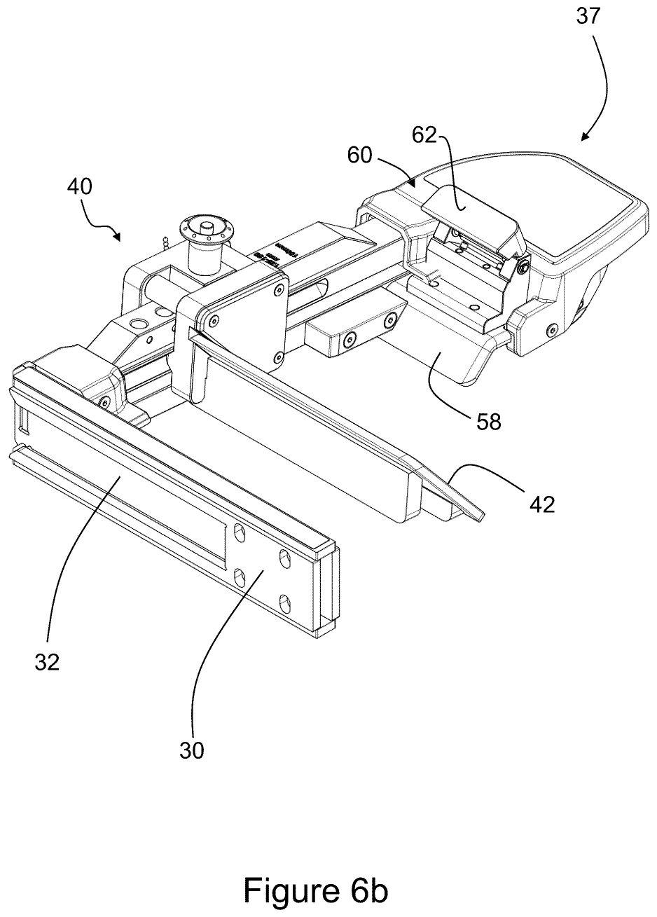

Referring now to FIGS. 6a and 6b, the end assembly 37 is provided with a hinged block assembly 60 which provides an additional adjustment means to accommodate differing wheel diameters by transitioning from an opened position (FIG. 6a) to a closed position (FIG. 6b). In the closed position (FIG. 6b), an upper block 62 juts forward into the space between plate 42 and ramp 58 so as to more securely fit wheels of a smaller diameter than in the open position. Consequently, in the opened position (FIG. 6a), the space between plate 42 and ramp 58 is wider so as to accommodate wheel diameters larger than possible in the closed position.

In a preferred embodiment, there are three slots 43 which, in combination with the adjustability of block assembly 60 enables attachment and support to wheels of diameters 100 mm, 125 mm, 150 mm, 200 mm, 250 mm, and 300 mm. In a more preferred embodiment, there are provided, in a closed block assembly 60 position, four slots 43 configured to provide a distance between plate 42 and ramp 58 to support wheel diameters of 100 mm, 125 mm, 150 mm, and 200 mm. If 250 mm or 300 mm wheels are to be engaged, the upper block 62 needs to be flipped up so that block assembly 60 is in an open position. However, it is to be appreciated that additional or adjusted slots 43, or any other suitable adjustments may be provided to accommodate wheels of different diameters as desired, without deviating from the scope of the present invention.

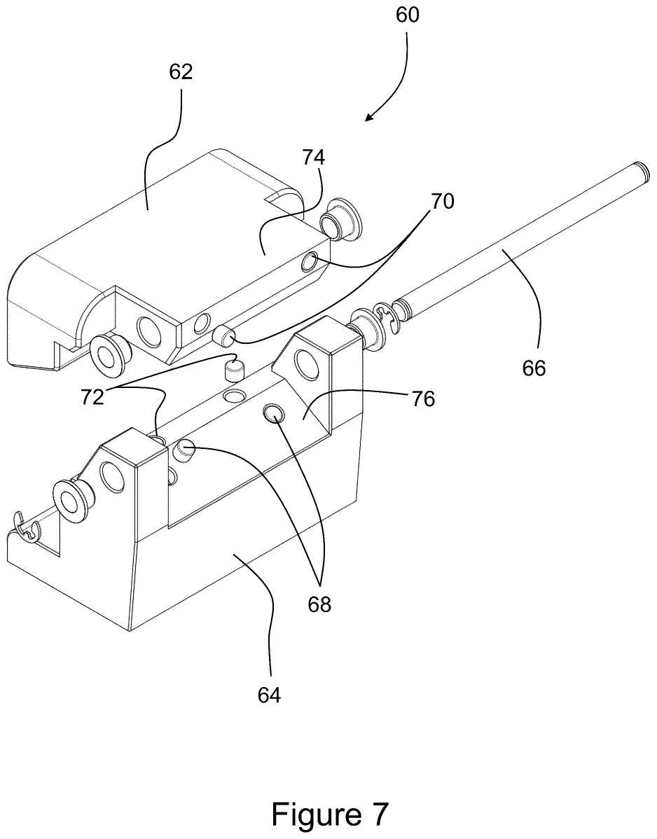

Referring now to FIG. 7, there is provided an exploded view of block assembly 60, comprising an upper block 62 hingedly (pivotably) affixed to a lower block 64 by an axle 66. Axles and their means of hingedly connecting multiple components is known in the art, including use of washers, spacers, and the like to produce a secure fit.

The block assembly 60 comprises a plurality of magnet sets to secure the block assembly 60 in the open or closed position while the bed mover 10 is being operated. In the illustrated embodiment, there is provided a first magnet set 68, a second magnet set 70, and a third magnet set 72. The magnet sets are configured such that in a closed position, second magnet set 70 attractively interacts with third magnet set 72 so as to maintain the closed position. To transition to an open position, sufficient force must be applied to overcome this attractive interaction between the second 70 and third 72 magnet sets. The upper block 62 is then pivoted about axle 66 such that a protrusion region 74 in which the second magnet set 70 is located is nested within a tapered region 76 where the first magnet set 68 is situated. The second magnet set 70 and first magnet set 68 then interact attractively to maintain the block assembly 60 in a closed position. It is to be understood that although reference is made to the block assembly 60 being transitioned between an open and closed position, the present invention is not to be limited to being transitioned between two such positions. Alternative arrangements may be made to the block assembly 60 enabling transition between intermediate positions, through being pivotably adjusted, without departing from the scope of the invention.

By providing an adjustable plate assembly and an adjustable block assembly, the space wherein a wheel is to be received may easily be adjusted by the user to accommodate different wheel sizes, without having to install and/or remove a spacer block. By providing three adjustable positions for the plate assembly, and two adjustable positions for the block assembly, the attachment means is capable of securely receiving wheels of six different diameters.

In contrast with the prior art, the present application utilises magnets in the jaw mechanism to resolve issues of rattling when the bed mover is in use. By comprising securely positioned magnets, there are few loose components which rattle as the jaw is being adjusted. As a result, unwanted noise is significantly reduced, helping to maintain a quiet hospital environment and minimising potential disturbances for both personnel and patients.

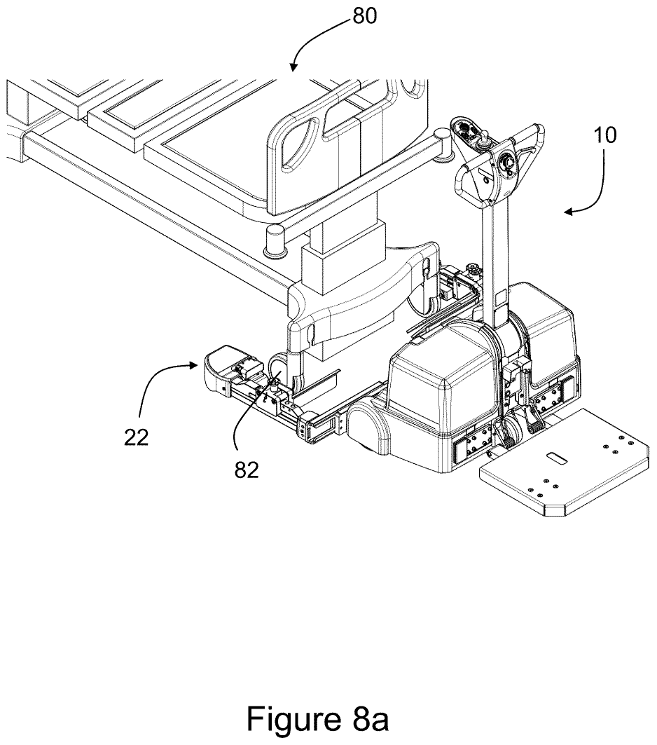

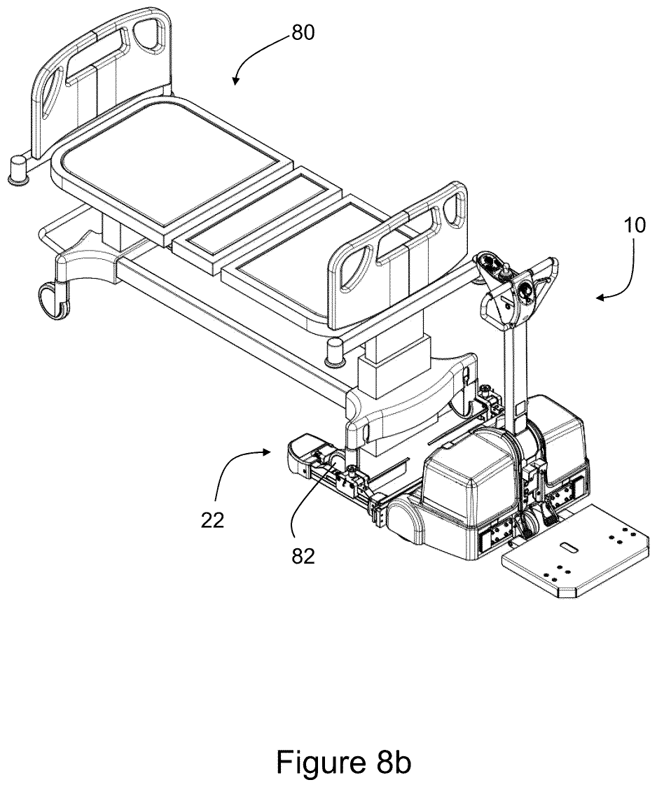

Referring to FIGS. 8a and 8b, a most preferred method of use of bed mover 10 and jaw assembly 22 for engaging wheels 82 of a hospital bed 80 will be made clear.

To engage wheels 82, the operator would position the bed mover 10 in front of a longitudinal end (having a narrower distance between wheels) of the hospital bed 80. Jaw system 22 is then lowered to an appropriate position, and block assembly 60 and plate assembly 40 manually adjusted to suit a desired wheel diameter. Jaw system 22 is then laterally extended via rail member 30 to accommodate for the distance between the wheels as in FIG. 8a. Once in position, the jaw system 22 is laterally closed as illustrated in FIG. 8b, securely engaging wheels 82. Once wheels 82 are engaged, the jaw mechanism 22 and bed 80 is raised, and may subsequently be transported by driving the bed mover 10.

The reader will now appreciate the advantages of present invention which provides for an improved bed mover having improved attachment means having manually adjustable components.

Although specific embodiments of the invention are illustrated and described herein, it will be appreciated by persons of ordinary skill in the art that a variety of alternative and/or equivalent implementations exist. It should be appreciated that each exemplary embodiment is an example only and is not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that, unless the context requires otherwise, the terms “comprise”, “comprising”, “include”, “including”, “contain”, “containing”, “have”, “having”, and any variations thereof, used in this document are intended to be understood in an inclusive (i.e. non-exclusive) sense, such that the process, method, device, apparatus, or system described herein is not limited to the features, integers, parts, elements, or steps recited but may include other features, integers, parts, elements, or steps not expressly listed and/or inherent to such process, method, device, apparatus, or system. Further, the terms “a” and “an” used herein are intended to be understood as meaning one or more unless explicitly stated otherwise.

Moreover, the terms “first”, “second”, “third”, etc. are used merely as labels, and are not intended to impose numerical requirements on or to establish a certain ranking of importance of their objects. In addition, any reference to positional terms, such as “lower”, “upper”, “inner”, “outer”, “beneath”, “above” and the like used in the above description are to be taken in context of the embodiments depicted in the figures, and are not to be taken as limiting the invention to the literal interpretation of the term but rather as would be understood by the skilled addressee in the appropriate context.

The phrase “and/or”, as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

1. An attachment means for a lifting and transportation device suitable for lifting and moving objects with spaced apart wheels, the attachment means comprising:
a pair of laterally adjustable spaced apart jaw members configured to engage wheels of an object;
each jaw member having a plate assembly and a block assembly having a space therebetween configured to receive one of the wheels;
wherein the plate assemblies are slidably adjustable along a length of their respective jaw member; and
wherein each of the plate assembly and the block assembly are adjustable such that the space therebetween can receive wheels of different diameters.

2. The attachment means of claim 1, wherein each of the plate assemblies comprises a surface positioned at an incline, wherein the incline is adapted to accommodate for a curvature of the wheel.

3. The attachment means of claim 1, wherein the plate assembly is slidably adjustable through a linear rail.

4. The attachment means of claim 1, wherein the plate assembly is slidably adjustable between three positions.

5. The attachment means of claim 1, wherein the plate assembly is retained in place using a pin inserted into a slot.

6. The attachment means of claim 1, wherein the block assembly comprises an upper block hingedly affixed to a lower block, such that the block assembly can be hingedly adjusted.

7. The attachment means of claim 6, wherein the block assembly can be transitioned between an open and a closed position.

8. The attachment means of claim 7, comprising a plurality of magnet sets configured to secure the block assembly in the open or closed position.

9. The attachment means of claim 8, wherein a first and second magnet set of the plurality of magnet sets retain the block assembly in the open position, and wherein the second magnet set and a third magnet set retain the block assembly in the closed position.

10. The attachment means of claim 1, wherein the space between the block assembly and the plate assembly is adjustable between six different positions.

11. The attachment means of claim 1, wherein the jaw members are supported on the ground by castor wheels.

12. A bed mover comprising the attachment means of claim 1.
